(19) United States
(12) Patent Application Publication
(10) Pub. No.: US 2014/0358884 A1
(43) Pub. Date: Dec. 4, 2014

(54) SYSTEM SAND METHODS FOR SEARCHING ITEMS OF FASHION AND OTHER ITEMS OF CREATION

(71) Applicant: Styloot Inc., Cambridge, MA (US)

(72) Inventors: Karthikumar NANDYAL, Mendham, NJ (US); Christian Stucchio, New York, NY (US); Mukti Khaire, Cambridge, MA (US); Samir Patil, Mumbai, MA (US)

(21) Appl. No.: 14/324,893

(22) Filed: Jul. 7, 2014

Related U.S. Application Data
(63) Continuation of application No. 13/672,815, filed on Nov. 9, 2012, now abandoned.
(60) Provisional application No. 61/557,445, filed on Nov. 9, 2011.

(51) Int. Cl. G06F 17/30

(52) U.S. Cl. CPC G06F 17/30864; G06F 17/30923
USPC 707/707

(57) ABSTRACT

Systems and methods according to the invention make feature-based and visual search possible. They allow users to provide us a visual representation that we can apply against available items of creation and return items that are like the visual representation in terms of features and other parameters that user can specify. More generally, the invention relates to searching items using visual representations. In particular it provides visual features of an item of creation and methods for recognizing images in terms of those features, and converting the deduced knowledge in a form that is searchable against a database of items of creation. Thus, for example, one aspect of this invention provides for creation of the framework in which an item of creation can be represented visually. This framework can be of many types. A canvas, if we are to draw an image akin to what an artist draws. Or a touch-sensitive computer screen if we are the give the user the ability to pick and choose the image that wants to be inferred and so on.

### BACKGROUND OF THE INVENTION

This application claims the benefit of filing of U.S. patent application Ser. No. 61/557,445, filed Nov. 9, 2011, entitled “System and Method for Constructing a Fashion Search Query with the Use of Croquis,” the teachings of which are incorporated by reference herein.

The invention relates to searching items of creation (e.g., fashion apparel, shoes, accessories, furniture, works of visual art). In particular it provides methods for searching items of creation that can use pictures, sketches, photographs and other non-textual inputs.

It is common practice to search the web (e.g., Google) or proprietary databases of items (e.g., Amazon) to look for items based on a series of criteria and textual descriptions. For example user types “brown suede shoes” in a search engine or an online shop and it returns all the results that are brown suede shoes. This is normally implemented by creating a large database of items and attaching text strings to them, which gets matched against a query and the results are displayed. Many online shopping sites use this mechanism to display wares that customers search for.

The problem with this approach is that it often does not fully capture the search intent. This is especially true in the case of items of creation where users are often looking for specific feature(s) that makes the item relevant to them (e.g., trousers with bell bottoms and drawstrings, handbags of a particular shape but with longer than normal straps, paintings with human figures in a landscape).

Another problem with the textual search definitions is that quality of the search results is poor. The reason is that the information being searched is not ordered or structured in a way that the query intent can be reasonably matched to what the user was looking for. This makes the results sparse and less relevant to the users. For example, a search for “trousers with bell bottoms and drawstrings” might not yield many results not because many such items of creation do not exist but because they have not been tagged in this way.

The problem of capturing the users intent and structuring the underlying data to be searchable for items off creation is an important gap in making search methods work better. This is so not just in the virtual world but also in the real world. For example, if a user walks into a large retail store and wants to find all the “trousers with bell bottoms and drawstrings” and their location in the shop it is a hard task. If the user then further wants to explore all the different types of bottom designs (e.g., bell bottoms vs. narrow) and closure mechanisms (zip vs. draw string) the task is intractable. This is not merely a matter of having better or more detailed descriptions of items but of being able to understand the visual aspect of the users intent. For example, not all users might use the term drawstrings to describe what they are looking for but they can often have a clear visual idea of what they want and what it looks like.

A related problem is that for items of creation search often requires finding combinations that the users want to select based on aesthetic or other criteria. For example, a user might want to create a “retro” look for themselves that is a combination of the bell bottom trousers a matching style shirt from that era. Again they may not be able to rely on a standard textual search for this because their intent could be hard to describe. For example, they could want to simply take a photograph of a person wearing such an ensemble and hope to find combination of items that look like what they found interesting.

### SUMMARY OF THE INVENTION

The foregoing are among the problems solved by our invention, which makes feature based and visual search possible. We do this by creating a system that allows users to provide us a visual representation that we can apply against available items of creation and return items that are like the visual representation in terms of features and other parameters that user can specify.

More generally, the invention relates to searching items using visual representations. In particular it provides visual features of an item of creation and methods for recognizing images in terms of those features, and converting the deduced knowledge in a form that is searchable against a database of items of creation.

Thus, for example, one aspect of this invention provides for creation of the framework in which an item of creation can be represented visually. This framework can be of many types. A canvas, if we are to draw an image akin to what an artist draws. Or a touch-sensitive computer screen if we are the give the user the ability to pick and choose the image that wants to be inferred and so on.

One aspect of the invention provides methods of inducting the image. In this aspect the invention address various methods of bringing an item of creation into a system where it can be matched and searched against a body of knowledge.

Another aspect of the invention provides methods and processes of breaking down the items of creation into structural features (i.e., sub-parts) so that it can be understood in a semantic and contextually relevant way. An example of a feature or a sub-part is a sleeve of shirt or a closure mechanism for trousers.

Yet another aspect of the invention provides methods of discerning the various possible attributes/values of the features (sub-parts) that is deduced from the whole image. Using our example from the above paragraph, attributes affixed could help us discern if the sleeve a long sleeve or a short one, does it have frills in it, is it frayed and such.

Yet another aspect of the invention provides processes and methods with which these deduced visual features and attributes are converted into a string of common words. This in essence converts what we see, into a structured searchable format. An example of this would be, seeing a frilled sleeve with a rose printed on and breaking it down into—A shirt first, then a sleeve, then frills, then printed, then floral print and then rose.

Yet another aspect of the invention provides for matching and searching these images, which are now broken down into structured text, against a body of knowledge, be it that of the world at large, or a corpus of one's own creation and control.

Yet another aspect of our invention provides a user the ability to visually mix and match various combinations and affect the display of results that are according to his or her choice. Let us take an example of a shirt. It is possible for the person to look at the visually deconstructed shirt and try to replace the half sleeves with full sleeves, add a collar, make is longer or shorter, and effect results that comprise of many shirts from real world, that have a collar and full sleeves and are of waist length.

Still other aspects of the invention provide client devices, server, and/or systems operating in accord with the foregoing.

### BRIEF DESCRIPTION OF THE DRAWINGS

A more complete understanding of the invention maybe attained by reference to the drawings, in which:

FIG. 1 depicts one system for realizing the invention through client-server architecture that uses a query app to communicate via a network with a query engine that can match items of creations to the query description;

FIG. 2 is a flowchart that depicts one way of implementing the invention of a query application that uses a visual depiction of a framework (in this case a mannequin) to search for items of creation (in this case fashion items);

FIG. 3 depicts one practice of the invention—system for showing an item of creation (a dress) on a mannequin with menu options that allow selection of various relevant features—the style or cut of the dress, the sleeves, and the neckline;

FIG. 4 depicts results from one selection of features—a knee length A-Line dress with an Ascot collar and associated search results—in a system according to one practice of the invention;

FIG. 5 depicts one system for realizing the invention through smart phone client-server architecture that uses a photo app to communicate via a network with a photo matching and query engine that can match items of creations to the photograph;

FIG. 6 shows a flow chart that depicts one way of realizing the invention of taking a photograph of an item of creation by user and emailing it to a service or software for retrieving items that are similar because they have a feature from the photograph;

FIG. 7 shows a flow chart for taking photograph as an input and identifying related items in a phone matching application in a system according to one practice of the invention;

FIG. 8 depicts one practice of the invention—an application to photograph an item of creation (a shoe in this case) and send it over a network to the Photo Matching Application;

FIG. 9 depicts an email with a photograph that is sent by the smart phone client software in a system according to one practice of the invention;

FIG. 10 depicts a user interface of a system for classifying the image in a type of item of creation and finding items based on related features in a system according to one practice of the invention;

FIG. 11 depicts a screen where a user of the phone matching applications narrows down a range of related items (example shoes);

FIG. 12 depicts a final output from the photo matching application—an email with items that are similar to the original photograph sent by the client—in a system according to one practice of the invention;

FIG. 13 depicts one system for realizing the invention through a client server architecture that gathers a database of items of creation (in this case fashion items), tags them based on features using software and human curators, and stores them in a tagged state for use by systems depicted in FIG. 1, FIG. 5 and FIG. 23;

FIG. 14 depicts a workflow for implementing a visually tagging system and saving items thus tagged to the database in a system according to one practice of the invention;

FIG. 15 depicts a workflow of the parser application to gather structured information from webpages of a set of providers of items of creation in a system according to one practice of the invention;

FIG. 16 depicts a sample html code from a source (vendor of fashion items in this case) that is typically processed by the parser in a system according to one practice of the invention;

FIG. 17 shows how a standard HTML browser renders the HTML code seen in FIG. 16;

FIG. 18 depicts how software for color extraction presents color options to the user in a system according to one practice of the invention;

FIG. 19 depicts an example text that the Software Tagger 15 uses to modify Bayesian probabilities of which category an item might belong to in a system according to one practice of the invention;

FIG. 20 depicts the user interface where the software tagger 15 (FIG. 13) shows items that have been tagged by it and allows a human curator to correct errors in a system according to one practice of the invention;

FIG. 21 shows a user interface of visual tagger 16 (FIG. 13) that shows items for more granular categorization by a human curator in a system according to one practice of the invention;

FIG. 22 shows one schema for a visually tagged database of items of creation (in this case fashion items) in a system according to one practice of the invention;

FIG. 23 depicts one system for realizing the invention through a client-server architecture that uses a Look matching application to create related sets of items of creation

FIG. 24 depicts a flow chart of how a human user can create an ensemble that matches the look of a photograph (or other item of inspiration/interest) in a system according to one practice of the invention; and

FIG. 25 depicts one example—four items that are assigned to a set of designs related to the Spanish designer Balenciaga—in a system according to one practice of the invention.

### DETAILED DESCRIPTION OF THE ILLUSTRATED EMBODIMENT

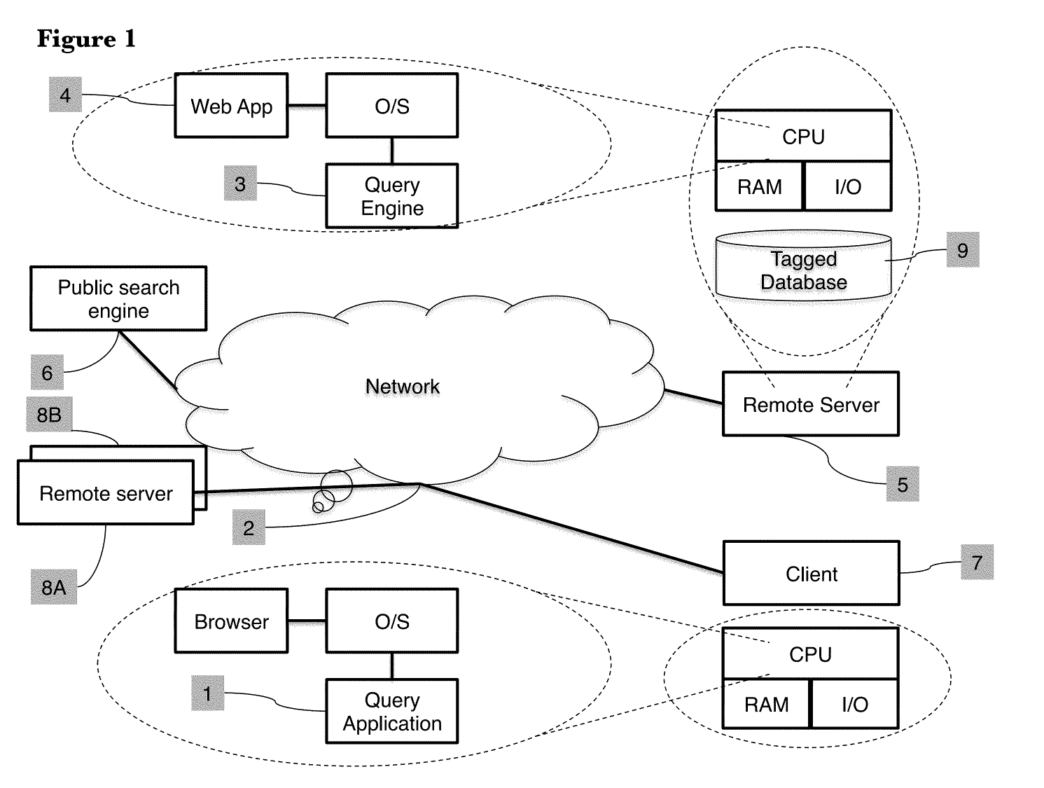

FIG. 1 depicts a system for searching of items of creation according to some practices of the invention. The illustrated system utilizes a client-server architecture, though it will be appreciated that other systems may employ peer-to-peer architectures or otherwise. Moreover, though the discussion below largely focuses on embodiments in which queries specified by a user are matched against information contained in a data set on a single server (or server cluster), it will be appreciated that the teachings herein can likewise be applied to such searches against a broader set of servers and other devices on a suitable network.

The illustrated system includes a client system 7 that is coupled to a cluster of servers 5 via network 2 and that comprises a conventional computing device of the type commercially available in the marketplace, such as a laptop computer, desktop computer, workstation, and so forth, as adapted in accord with the teachings hereof. It will be appreciated that the client 7 can, as well, be a mobile computing device, e.g., a smart phone, personal digital assistant (PDA), and so forth, as adapted in accord with the teachings hereof. Moreover, it can be an embedded computing device as adapted in accord with the teachings hereof. Regardless, the client system 7 can transmit and/or receive information, e.g., with network 2, via wired or wireless communications, all in the conventional manner known in the art as adapted in accord with the teachings hereof.

Illustrated client device 7 includes central processing unit (CPU), memory (RAM), and input/output (I/O) subsections of the type commonly incorporated in respective devices of the type discussed above. Those subsections may include and execute (particularly, for example, in the case of the CPU) an operating system, a web browser and/or other software of the type commonly provided and configured for execution on such devices, again, as adapted in accord with the teachings hereof. Those subsections may, further, include and execute additional software effecting the functionality discussed below and elsewhere herein attributed to the respective device 7 such as query application software 1, query engine software 3 etc., as shown. In other embodiments, the query application functionality may be consolidated within or distributed among one or more other digital data processors (illustrated or otherwise) without deviating from the teachings hereof

The client system 7 may, further, include a display (not shown) of the type commonly used in respective devices of the type discussed above, e.g., for the display of information in web browsers, applications, apps or otherwise. And, the device 7 can include a keyboard (virtual, physical or otherwise) of the type commonly employed on such devices, e.g., for the input of information into web browsers, applications, or otherwise.

Servers 8A, 8B comprise conventional digital data processors of the type commercially available in the marketplace for use as search engines or other server, such as, personal computers, workstations, mini computers, mainframes, and so forth. Those servers, too, may include central processing unit (CPU), memory (RAM), and input/output (I/O) subsections of the type commonly incorporated in respective such devices. Those subsections may include and execute (particularly, for example, in the case of the CPU) an operating system and web server software of the type commonly provided and configured for execution on such devices.

Illustrated server 5 may particularly, for example, be adapted in accord with the teachings hereof, e.g., via inclusion of additional software, e.g., query engine 3, executing on those subsections, effecting the query (or “search”) functionality discussed herein attributed to server 5 in the discussion below. Those subsections of device 5 may, as well, execute a web server 4, providing an interface, e.g., between users operating device 7 and the query engine 3 executing on device 5. In other embodiments, the query engine functionality may be consolidated within or distributed among one or more other digital data processors (illustrated or otherwise) without deviating from the teachings hereof.

Network 2 comprises a combination of one or more wireless, wired or other networks of the type commercially available in the marketplace for supporting at least intermittent communications between the illustrated devices (e.g., client system 7) including, for example, LAN, WAN, MAN, cellular, Wi-Fi, local area, satellite, and/or other networks. Although only a single network 2 is shown in the drawing, it will be appreciated that in other embodiments multiple networks may be employed.

Illustrated server 6 comprises a public search engine of the type known in the art and/or commercially available in the marketplace. This can include public search engines such as Google, Yahoo! and so forth, that apply queries against publicly accessible data maintained by servers throughout the world. These can also include semi-private and private search engines that restrict usage of search functionality to registered members and/or that conduct searches among segregated and/or specialized data stores (e.g., Craig's List, Monster.com, Lexis/Nexis, Morningstar, and so forth). And, as above, in other embodiments, the search engine functionality may be consolidated within or distributed among one or more other digital data processors (illustrated or otherwise) without deviating from the teachings hereof.

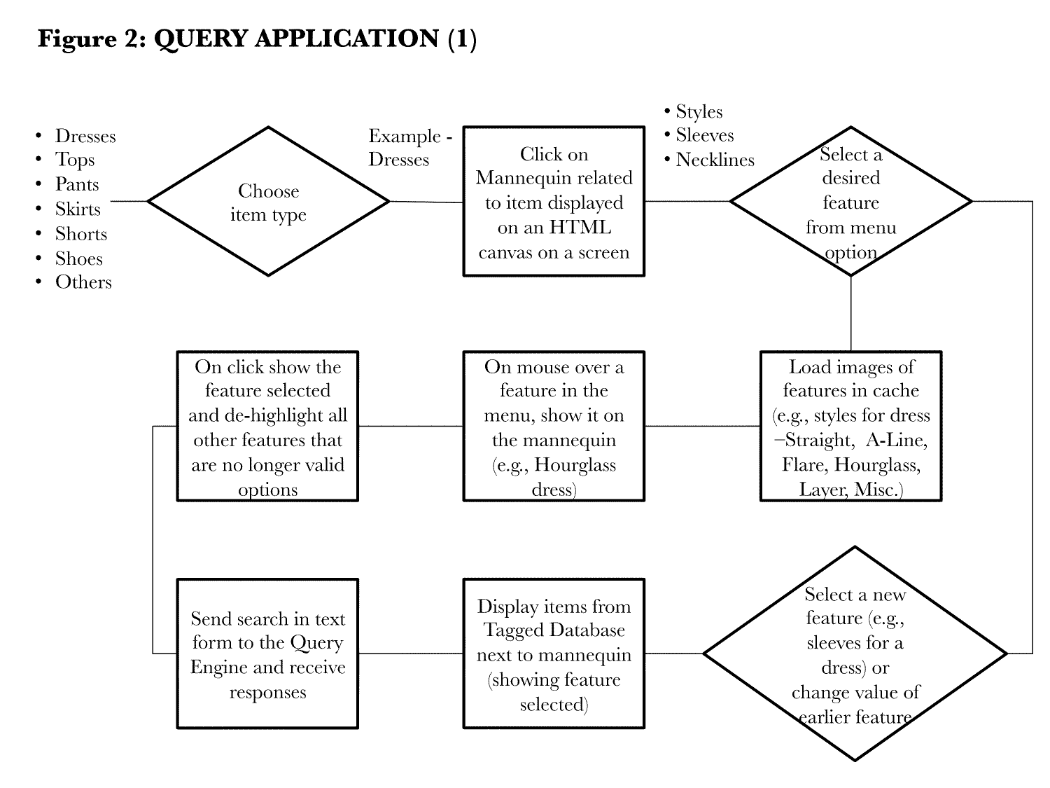

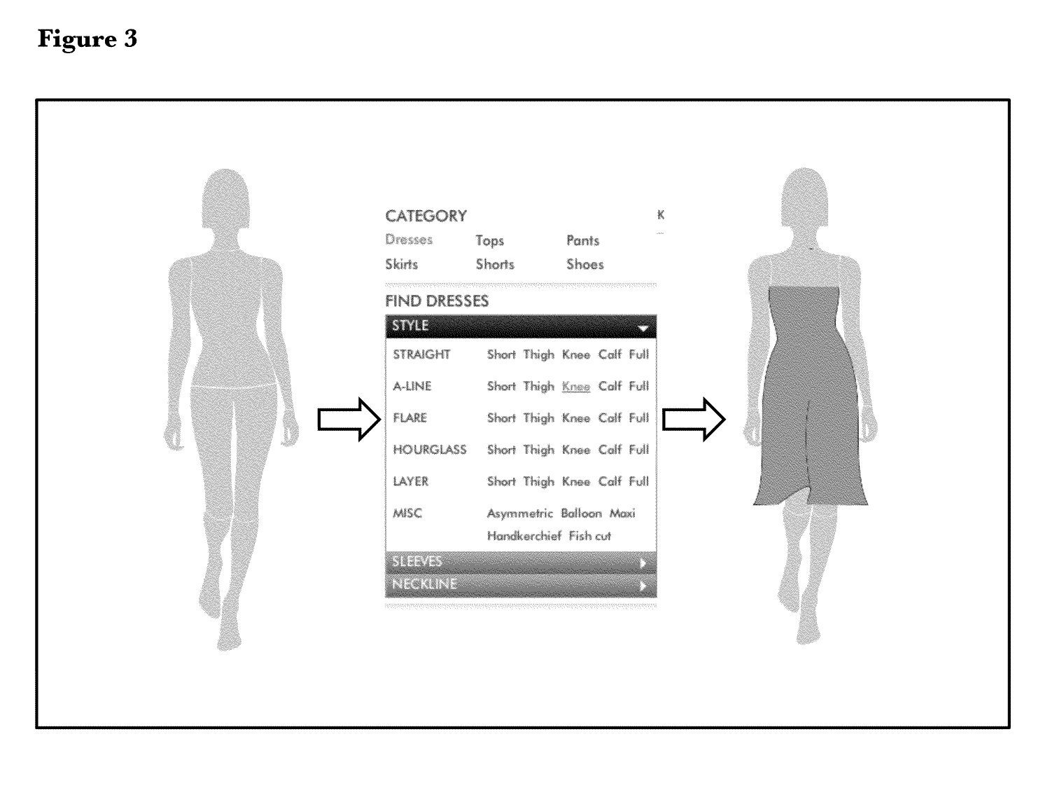

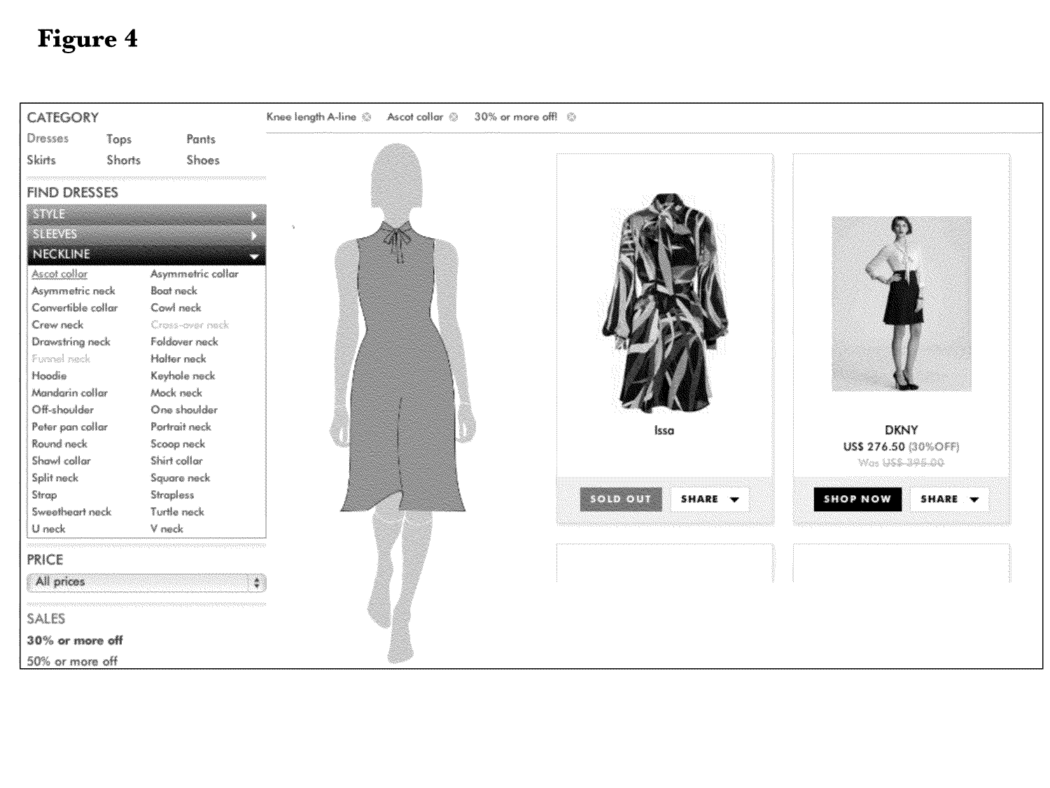

FIG. 2 illustrates the workflow of the query application to visually depict an item of creation by selecting from a menu in a system according to one practice of the invention. The specific implementation shown in FIGS. 3 and 4 uses an HTML point and click interface that can be used on a client (like client system 7 shown in FIG. 1) select various features of a dress. The same system can also be used to select various options for tops, skirts, tops, pants, shoes and other similar items of creation. This is just one type of client implementation and for one type of item of creation (fashion items). For example, a similar system can be constructed with a large touch screen where the user directly picks features or drags/drops from a menu onto 2D or 3D visual representations of items of creation. The order in which feature options are presented—simultaneously or sequentially—can also be changed.

For example, FIGS. 3 and 4 show a specific instance of how a fashion item can be visually depicted by using the system and then used to find items. In this case it is a dress in A-line style with an Ascot collar neckline. For every feature selected the systems creates a search query that it then runs against a tagged database of apparel, accessories, and shoes. This search query is communicated to a query engine (3) running on a remote server 5 (shown in FIG. 1). The query engine is standard interface to the database that given the parameters from the query application returns all the items in the database that have the selected feature. The items and their descriptions are then sent over the network 2 using standard Internet protocols. The items are then displayed by the query application on the client system 5. For example, when the user selects A-Line knee length dress it shows all such dresses, when the user selects a type of neckline (Ascot) it narrows the results to those that have both features and so on. To ensure that the results are accurate and fast the database includes an inventory of items tagged with categories (dresses, tops, shoes, etc.) and all relevant features for all categories (e.g., for dresses, various styles, necklines, and sleeves). By matching the search query to the items the system identifies all items that have those features. The matching items are then sent over the network 2 to the client 7.

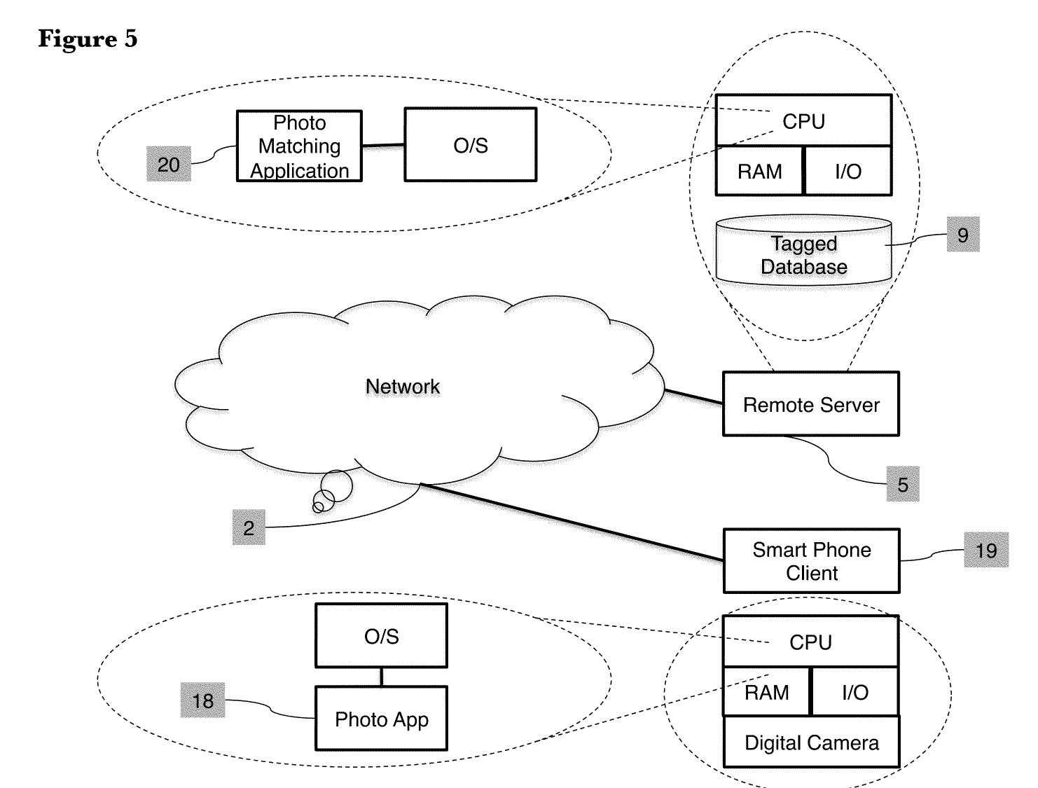

FIGS. 5, 6 and 7 depict another system and process for searching of items for creation according to some practices of the invention. The illustrated system utilizes a smart-phone-client-server architecture, though it will be appreciated that other systems may employ peer-to-peer architectures or otherwise. Moreover, though the discussion below largely focuses on embodiments in which queries specified by a user are matched against information contained in a data set on a single server (or server cluster), it will be appreciated that the teachings herein can likewise be applied to such searches against a broader set of servers and other devices on a suitable network.

FIG. 5 depicts a system like that of FIG. 1 for the query application, albeit that permits the user to designate an item to be searched by way of a photograph or other pictorial illustration sent via email other communication systems to the photo matching application shown (20). The system is generally constructed and operated as described above and as further discussed below. The key difference is that client system in this case is a smart phone (or other similar portable device) 19 that has the ability to take photographs of an item of creation. Like in the system depicted in FIG. 1 this client is coupled to a cluster of servers via a network all in the conventional manner known in the art as adapted in accord with the teachings hereof.

FIG. 5 illustrates operation of a system according to the invention and, more specifically, for example, of photo application 18 to facilitate a user's taking a photograph of an item of creation by selecting from a menu in a system according to one practice of the invention. The specific implementation shown here uses a smart phone interface that can be used on a client (like client system 19 shown in FIG. 1).

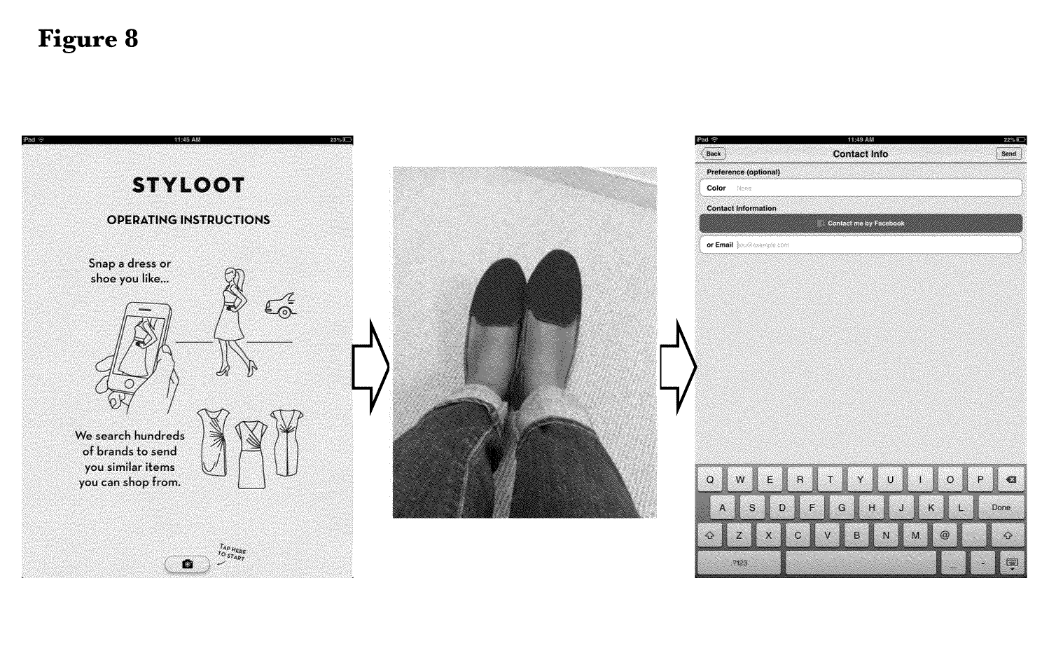

FIGS. 8-12 illustrate operation of a system according to the invention and, more specifically, for example, of client application 18 to facilitate a user's taking a picture, make changes, add comments and email the picture through the application. Once the photo matching application receives the email (20 in FIG. 5) it can be analyzed by computer software or a human curator or a combination of the two, to match the photograph to an item of creation with similar or same features.

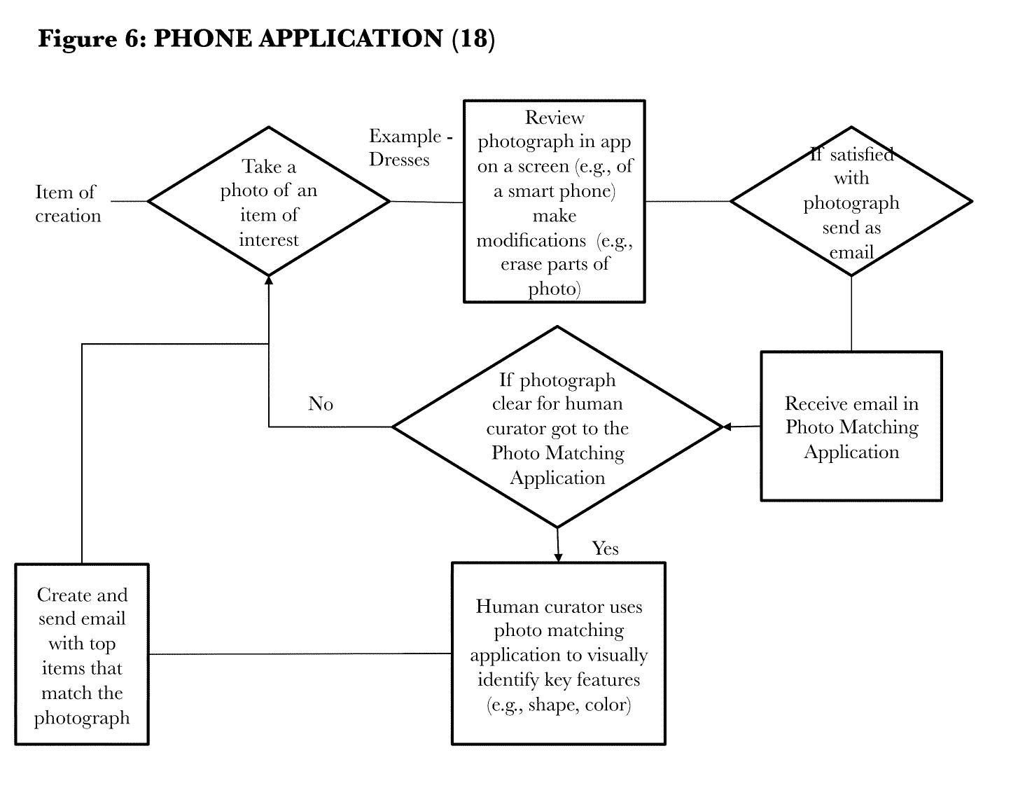

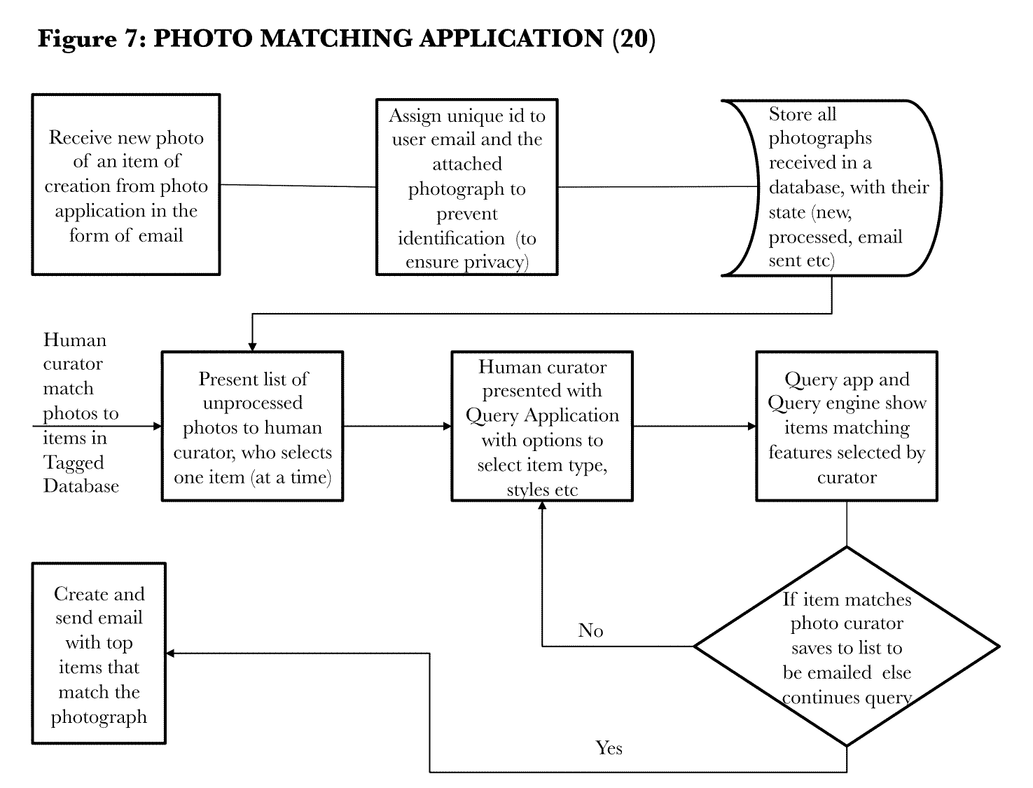

FIGS. 6 and 7 describe the logical steps of how a photo application operated by the end user and a photo matching application operated by human curator can visually find items that look like the item of interest (e.g., a photograph, sketch). The photo application captures a depiction of item of fashion in the form of an image (it can also be other types of item of creation and other type of visual depiction such a sketch) and sends it to the photo matching application. The photographic or other kind of depiction does not need to capture the full image it can even be a part (feature) of the item of interest.

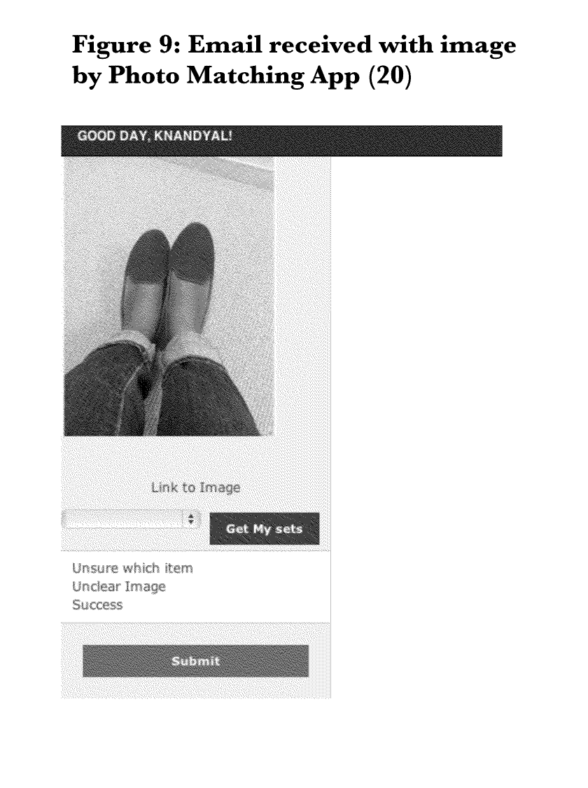

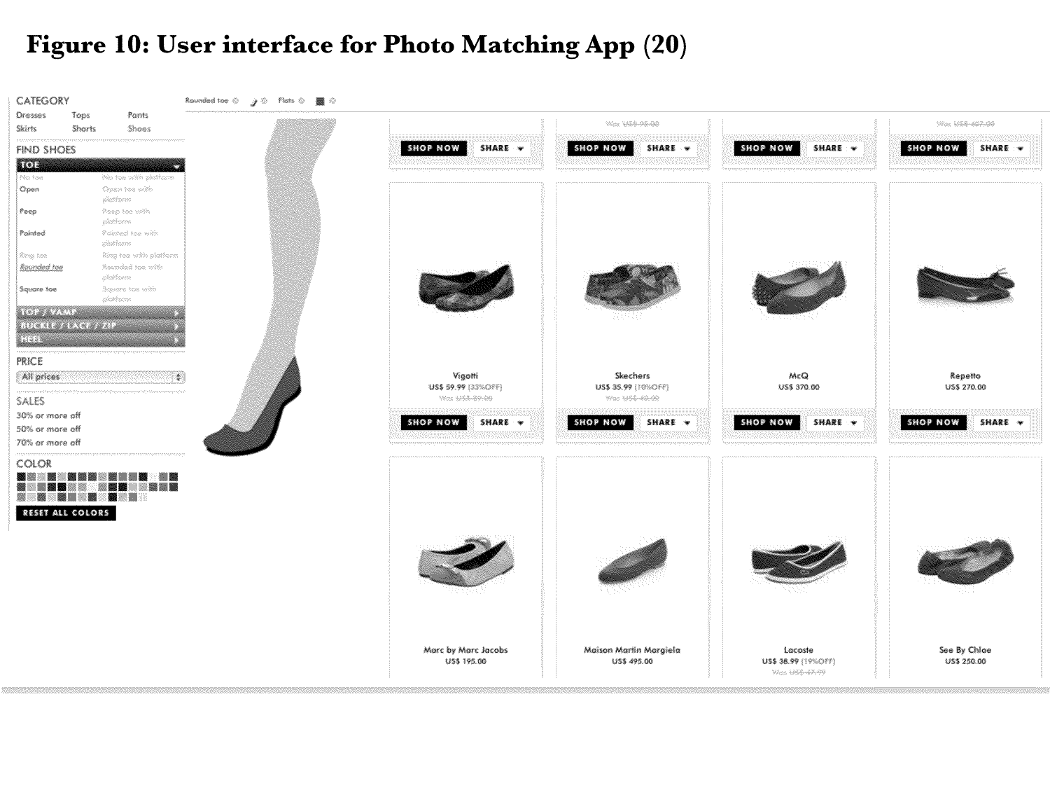

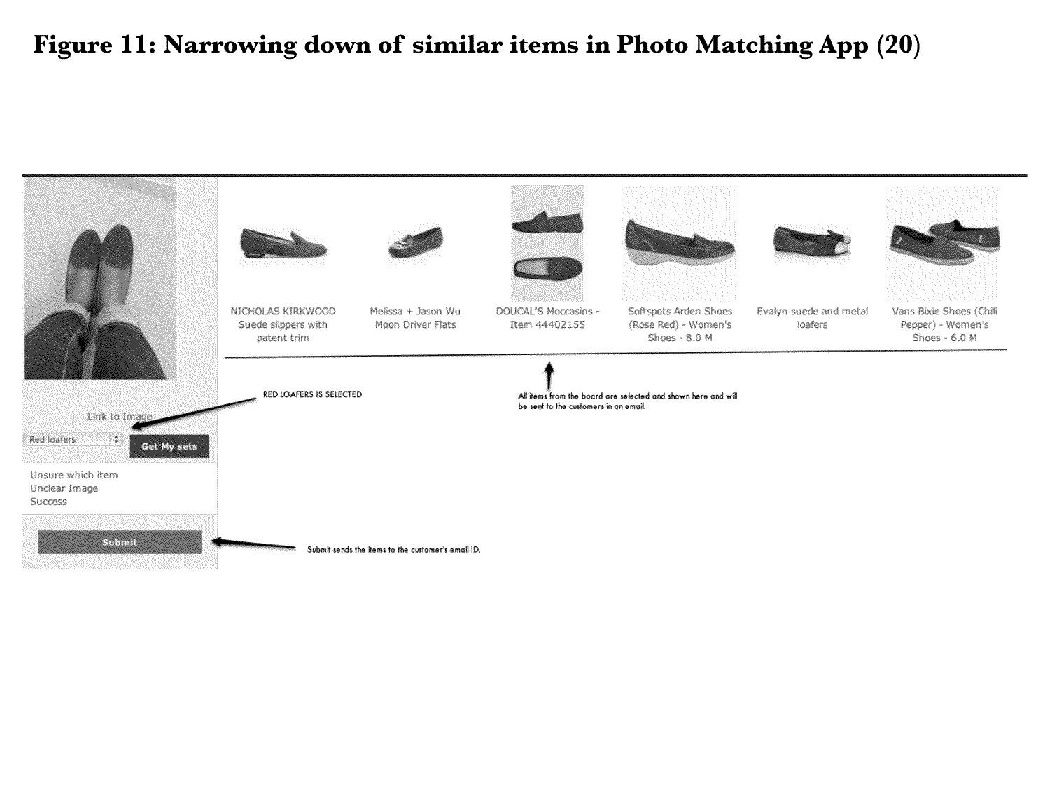

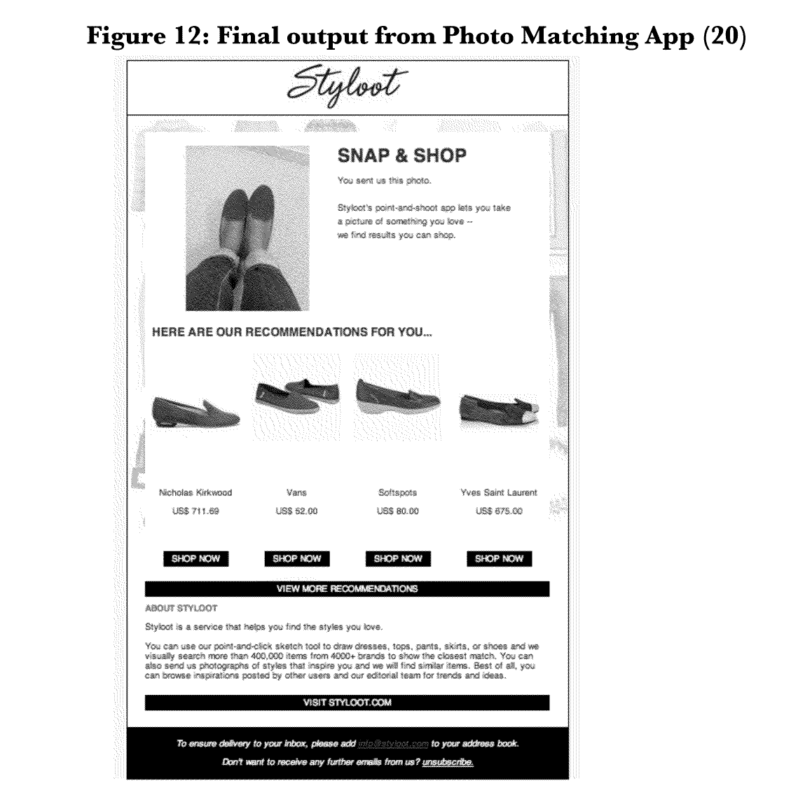

As shown in FIG. 7, a human curator looks at the image, uses an interface of the type shown in FIGS. 9-12 to identify items that look like the image. This is best explained with an example; FIG. 9 shows a sample email with a photograph of a shoe. The photo match application process shown in FIG. 6 allows a human curator to classify the incoming photograph into items of creation (e.g., type—shoe, style—loafer). The same method can be used for many types of items of creation where successive selection of a feature defines the item. For every feature selected the system creates a search query that it then runs against a tagged database of apparel, accessories, and shoes. This search query is communicated to a query engine 3 running on a remote server 5 (shown in FIG. 1 and FIG. 5). The query engine identifies all the items in the database that have the selected feature. These items and their descriptions are then sent over the network 2 using standard Internet protocols. The items are then displayed by the photo matching application running on the server system. FIG. 10 shows an example of this for the shoe photograph. The human curator can refine the search based on features until they find a match that visually looks closest to the image received from the phone application. FIG. 11 shows the shortlist of items that the human curator has saved by querying the system for matches. The curator can then pick from the list of similar items the ones that are the closest match and share the list with the end user who sent the image. FIG. 12 shows one way of sharing the images via email.

The unique aspect of this process is that it combines human curators and software in a way that the photo matching can work not just for the “whole” image but for a part as well. For example, if a user sends in a photograph of only a “frilly collar” the system can identify all items that are logically (semantically) connected with a frilly collar, these may be dresses long and short, shirts of various styles as long as they have a frilly collar and so on. In this aspect it is a “find by photo” application that can identify an item of creation based on feature (sub-part) that is linked to the interest of the user (i.e., an aspect of design or creation that appeals to them).

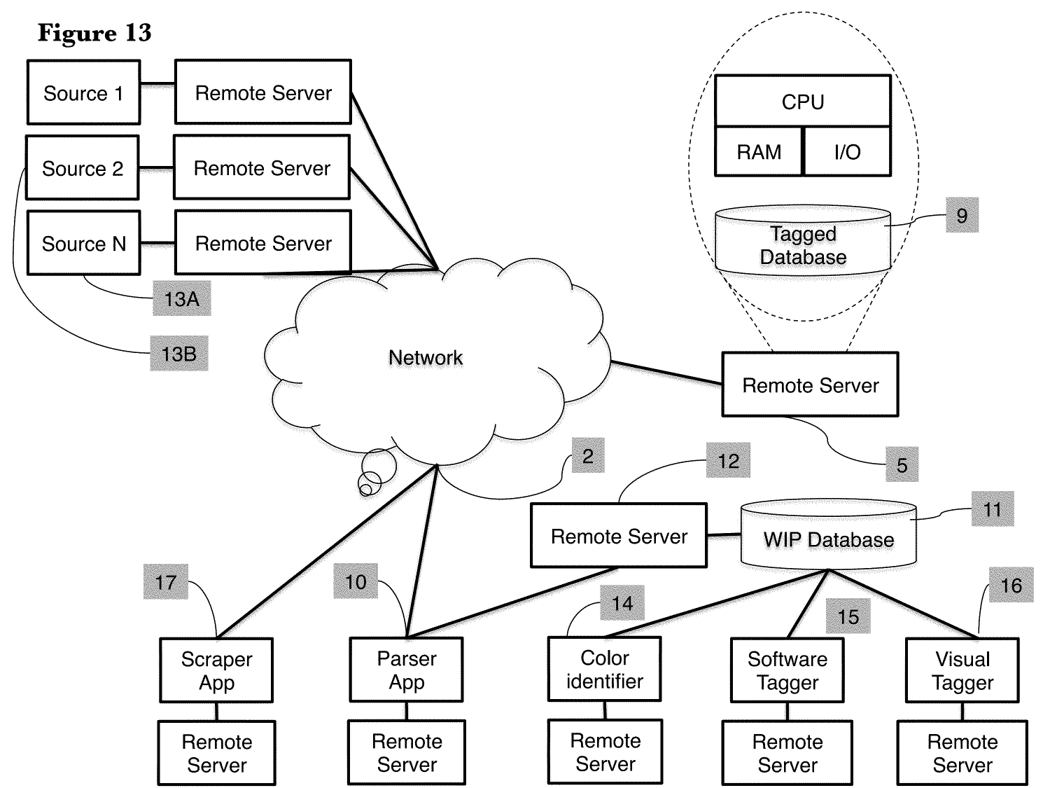

FIG. 13 depicts one system for realizing the invention through a client server architecture that gathers this database of items of creation (in this case fashion items), tags them based on features using software and human curators, and stores them in a tagged state for use by systems depicted in FIG. 1 and FIG. 5;

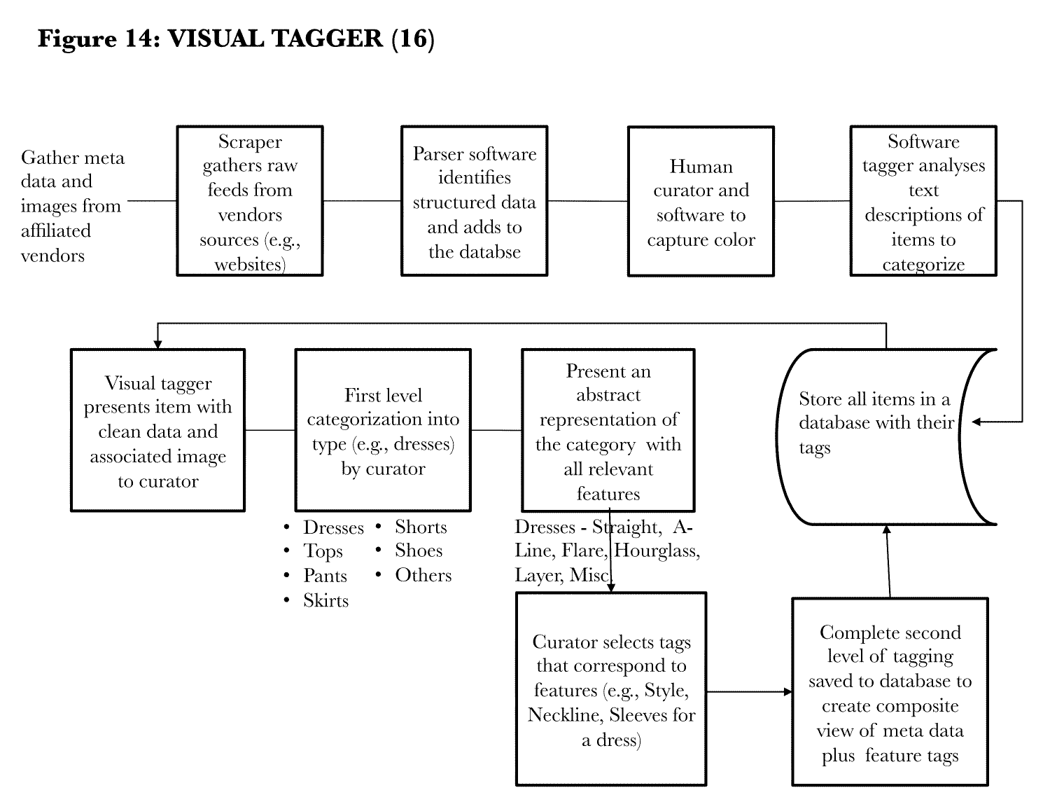

FIG. 14 depicts the workflow for implementing a visually tagging system and saving items thus tagged to the database;

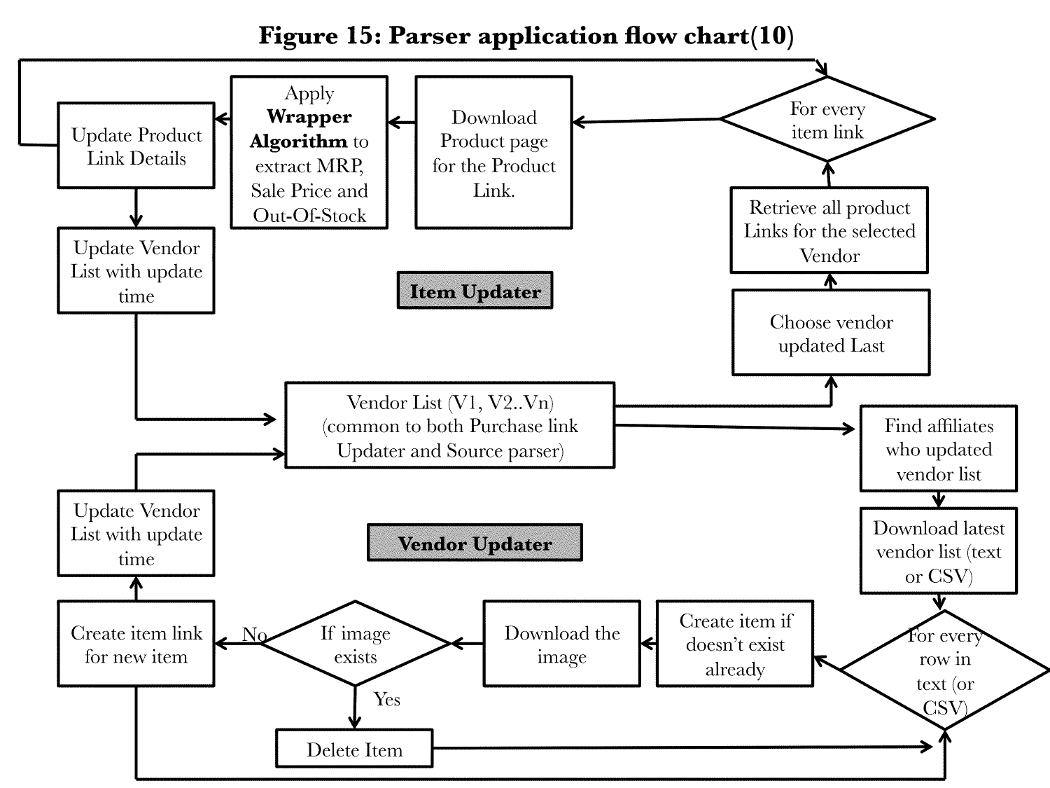

FIG. 15 depicts the workflow of the parser application to gather structured information from webpages of a set of providers of items of creation;

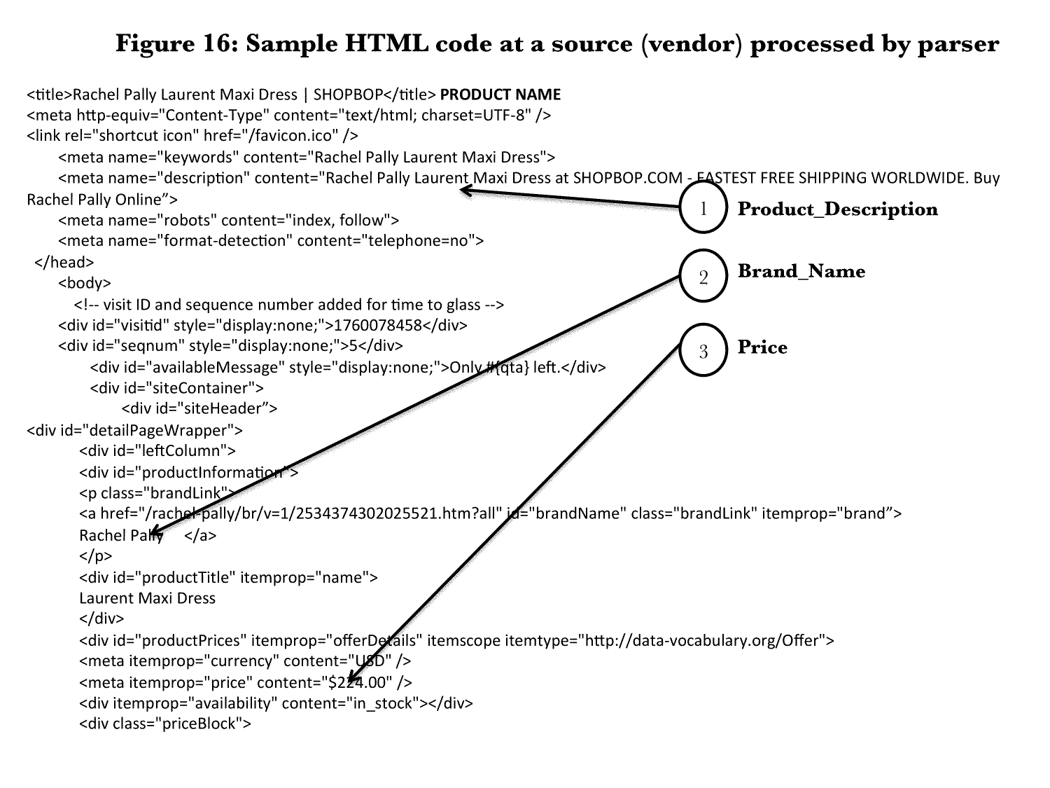

FIG. 16 depicts a sample html code from a source (vendor of fashion items in this case) that is typically processed by the parser;

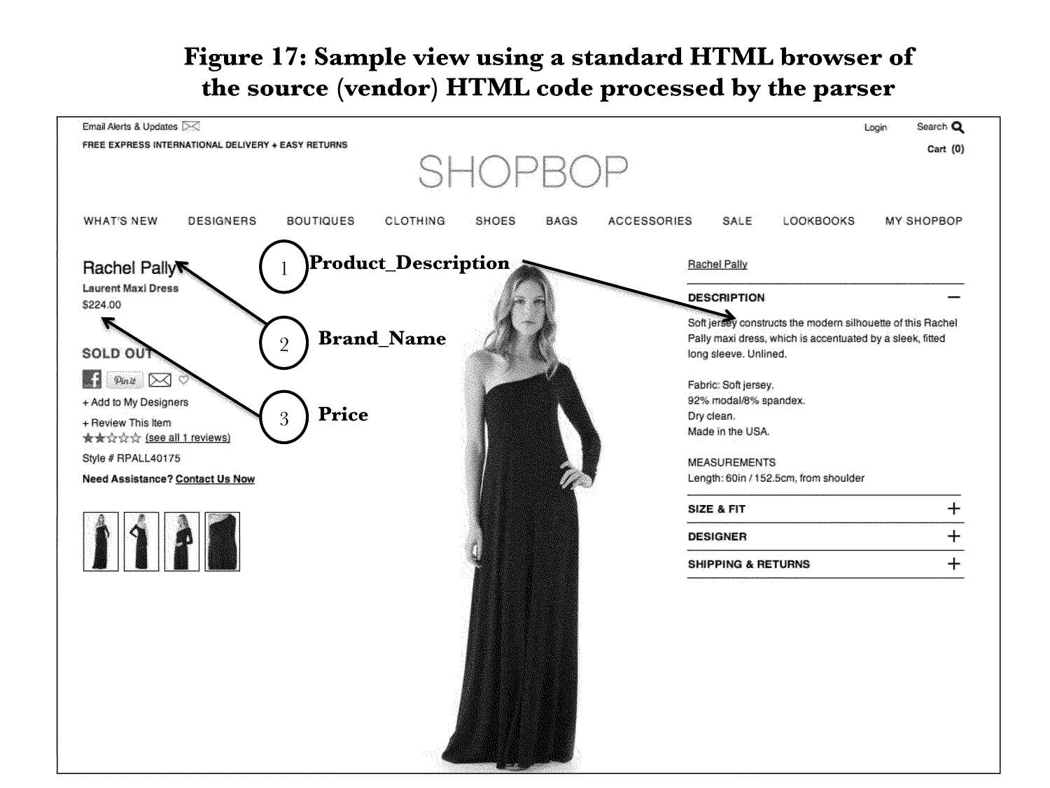

FIG. 17 shows how a standard html browser renders the html code seen in FIG. 16;

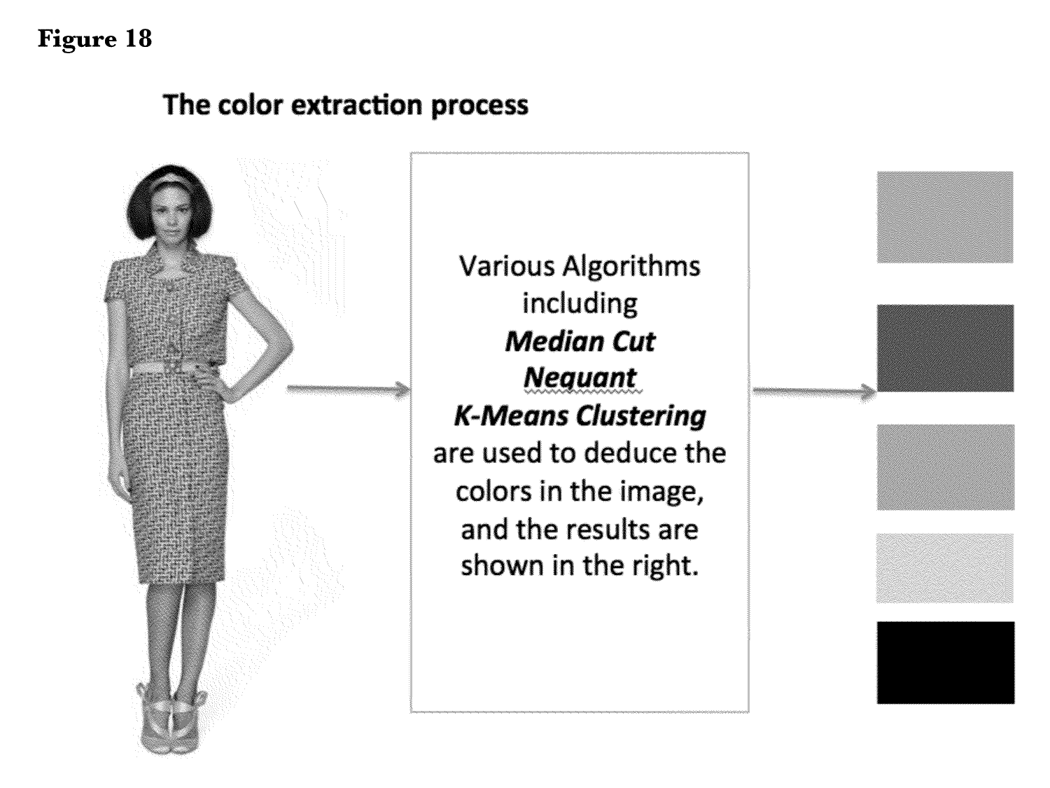

FIG. 18 depicts how the software for color extraction presents color options to the user;

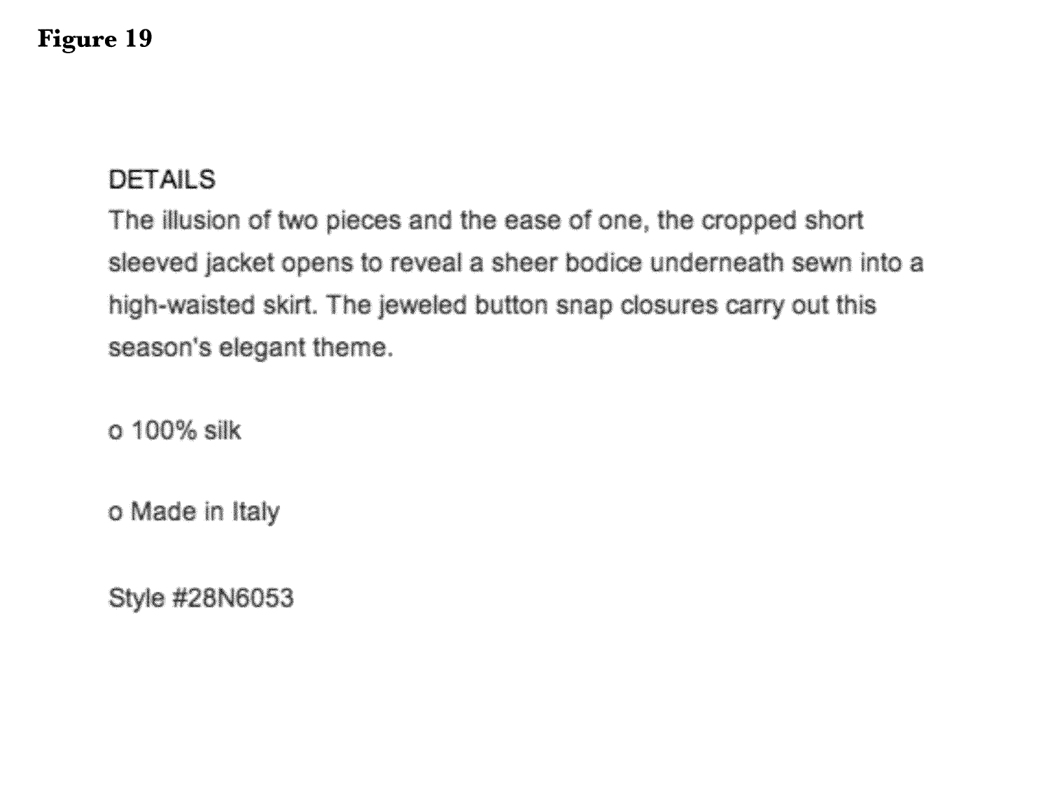

FIG. 19 depicts an example text that the software tagger 15 uses to modify Bayesian probabilities of which category an item might belong to;

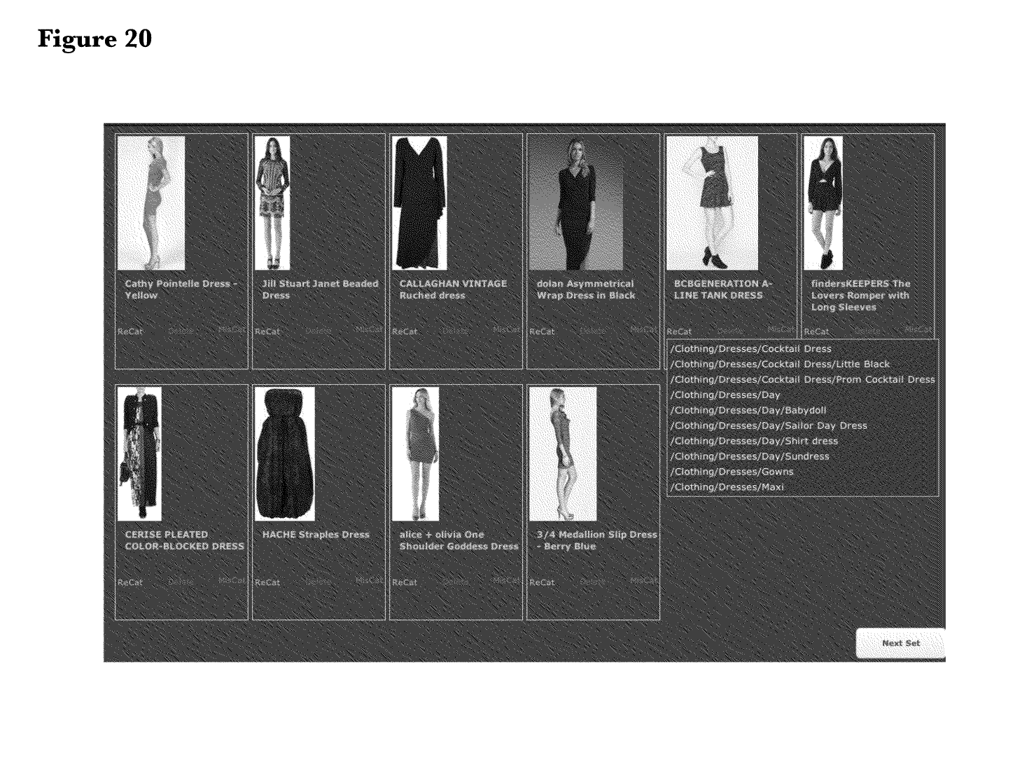

FIG. 20 depicts the user interface where the software tagger 15 (FIG. 13) shows items that have been tagged by it and allows a human curator to correct errors;

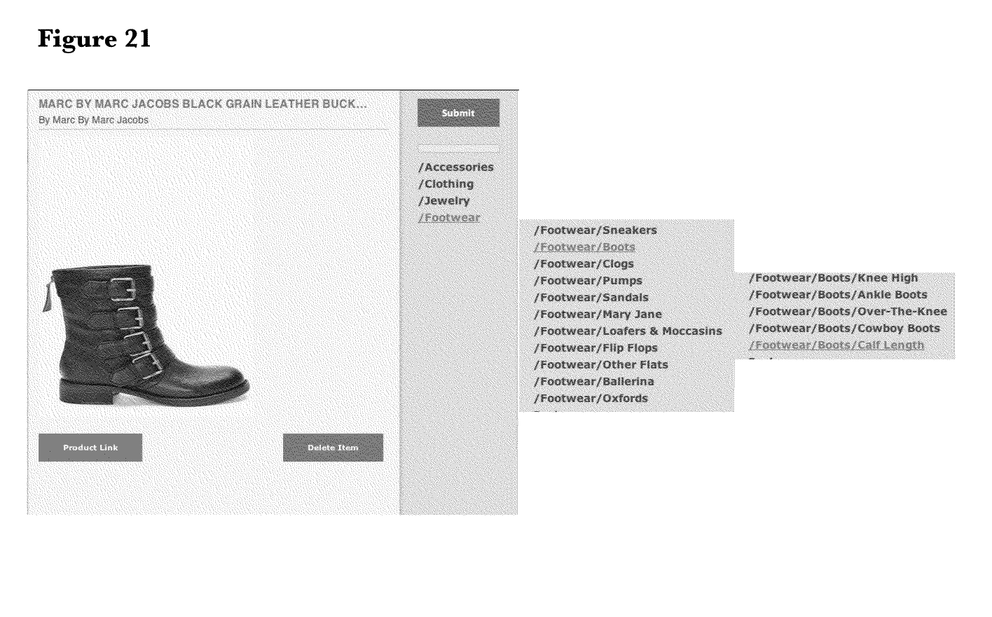

FIG. 21 shows the user interface of visual tagger 16 (FIG. 13) that shows items for more granular categorization by a human curator;

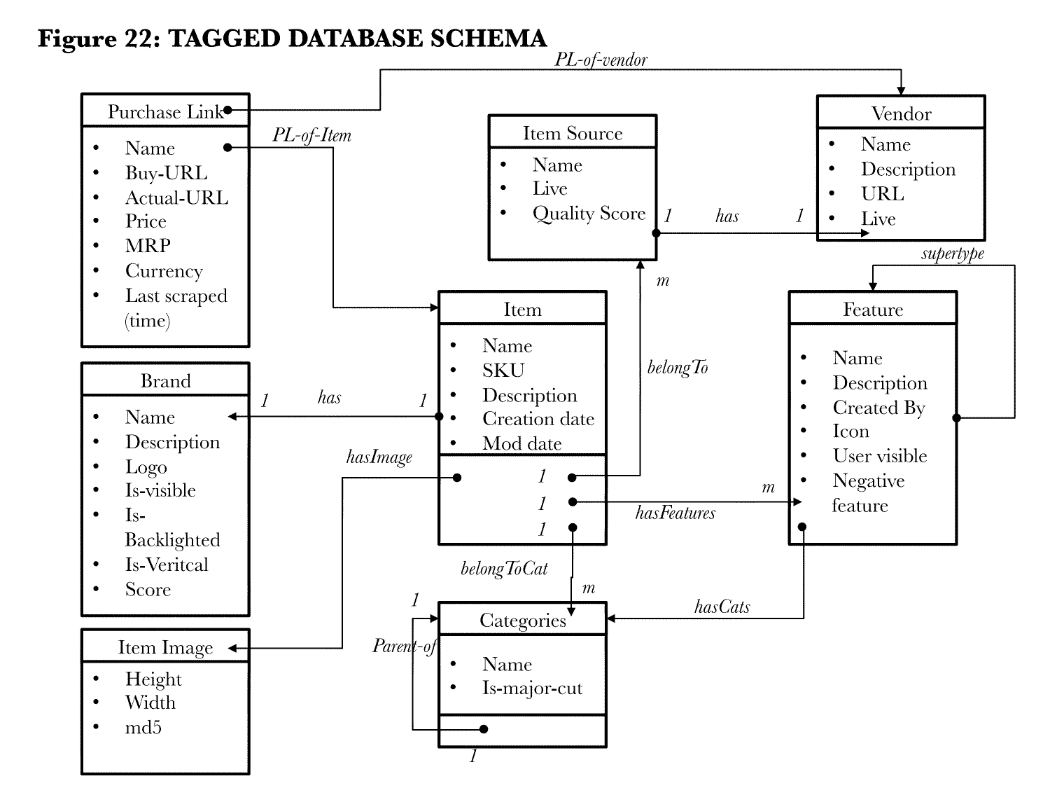

FIG. 22 shows one schema for a visually tagged database of items of creation (in this case fashion items)

Referring to FIG. 13 and FIG. 14, the parser 10 is the part of the system that seeks out sources, makes sense of the items found in these sources, and prepares the items in a way that can be inducted into WIP Database 11 (FIG. 13) and the remote server. The sources are websites that contain various items of merchandise and normally run a http service (a web server) that makes it possible for users to access these items of merchandise via their remote PCs using a browser like Internet Explorer. The remote server displays these items with a set of parameters like price, description, size along side to each of these items.

FIG. 15 shows the workflow for a parser application implementation. The parser has two parts—one that keeps the source list (in this implementation the vendors of fashion items) up-to-date and an item updater that for each vendor keeps every item updated (e.g., for price, availability, images and other meta data). Since different sources (most often websites, but not necessarily only websites) hold and show items (mostly merchandise but not necessarily only merchandise) differently the parser requires a method to be able to process them all efficiently. This piece of software needs to understand the structure of various sources, parse the HTML (the language web pages are written in), and store structured information into a database (11 in FIG. 13).

The way the parser “reads” a webpage is by evaluating the HTML source of the web page. HTML is a language that is structured in a root-tree-branch-leaf hierarchy. By starting from the root and ‘walking’ down each and every leaf, we can get an understanding of all the components of a web page that an end user sees. Since mapping all the leaves is a wasteful exercise and we care for only information that is pertinent there is a need for a specialized system to execute the parsing process efficiently. For example, FIGS. 16 and 17 show a sample HTML code and related view of the same code for a source of an item of creation (in this case an online shop for fashion items). For the purpose of creating the tagged database, we are interested in specific item data the Figures show three examples that we want to add to the database—description, brand name and price. The parser has to find that data by “reading” the html code. This information could be at the root or any of the leaves of the page. To make this targeted search efficient a system using a “Depth First Search” (DFS) algorithm is implemented for a crawl-and-learn process (i.e., follow—crawl all the links in a given HTML page and find relevant data).

In the wrapper algorithm referred to in FIG. 15, for each vendor, a human user lets the system know how “deep”—how many branches—it needs to walk down and which leaves it needs to be concerned with. For example, in the case shown in FIGS. 16 and 17 the system can be told that description, price and brand name is available at the first (root level). For each data item of interest, the user of the system associates a tag (e.g., STYLOOT DESCRIPTION) and the level at which is found for that source. This process is done once for each vendor. Once the system has learnt the structure of a source's pages it can parse the page automatically. If the vendor changes the data item location one level above or below the original location that the human operator “taught” the algorithm is flexible enough to extract data from a level above or below.

In addition to “meta” data (like price, description, and other parameters) tagging accurately for color is a key requirement for items of creation. The color identifier 14 is the part of the process that extracts colors from images imported from the source. The key issue is that an image may have multiple colors that are not directly associated with the item that is being tagged. For example, as shown in FIG. 18 a fashion related image might have a model showcasing the dress, the system needs to differentiate the color associated with the model (for example, skin tone or hair color) vs. from the fashion item. The color identifier 14, uses a clustering algorithm (e.g., K-Means, other like Median Cut or Nequanta can also be used) to identify all the dominant color swatches in the image. For complex images as shown in FIG. 18, a human curator picks from the swatches of color presented. The colors are interpreted and stored using CIE 1931 XYZ color space. Once the items are tagged, items of similar colors can be retrieved with a query.

In addition to parsing the HTML for meta data and tagging for color one of the critical steps in tagging the item is categorizing it accurately (e.g., short, A-Line, dress). Software tagger 15 is the part of the process where an item gets categorized into the kind of item of fashion it is (e.g., shoe or a watch?). The categorization is critical for reducing the human effort in the next step (visual tagging). The system uses properties of the item and its source price, description, brand, stated category, and other textual information usually found for an item of fashion. In one practice of the invention, a look-match-place-check-learn-tighten cycle with Bayesian algorithms can help categorize items before the next step of Visual Tagging by human curators.

There are many techniques and methods to implement Bayesian logic, with regards to categorization. We use Naïve Bayes classifier since it can work with a small data set for training and is also based on the assumption of strong independent variables. Like any Bayesian technique, it needs to be trained on an existing data set. We provide this training set, by initially parsing 100,000 items of fashion across categories, saving all the descriptions and product names and brands into a Database. We ignore common articles, pronouns and adjectives by looking them up against online English grammar repositories. The word set that remains is sent to a human who looks at each word and labels 3-4 categories this word can occur most commonly in, in order of decreasing possibility. An example is the word Nike. It is most likely to appear in shoes first, then in sports apparel, then in watches and then in sunglasses. Another example is the word Dial, which has a high likelihood to mark the item as a watch, then a phone and then customer support and such. The human curator assigns each of the words in the dictionary a probability based on their best guess. For example, for the Dial word case the ‘seed’/starting probabilities could be 90% for a watch, 60% for a phone, and 40% for customer support.

When an item is imported for the first time into our environment, the description, brand, etc. are matched against this dictionary based on the probabilities that were provided initially and placed in a category based on that. Many such items are imported in a batch and placed in respective categories, and then photos of the items and the category is shown to human curators to identify the mismatches. For the mismatches, based on the correction provided by the curators on where the item ought to have been placed, the Naïve Bayes method re-computes probabilities, which will be effective from the next time items are imported. For example, after a cycle of import and readjustment the probability of an item that has the term “Dial” in its description may be modified from the originally assigned 90% to say 88% by the Naïve Bayesian method. In this way the system uses the Bayesian adjustments coupled with human correction to “learn” more and more accurate automatic categorization. Without this Software Tagger (15, FIG. 13) the task of categorization will require far greater human effort.

The FIG. 19 shows, the description of a Jacket. In that example, the following words are placed in a bayesian structure, which makes an informed guess of what this product is from past encounters of such words in close proximity. The words from the above example that places this as a dress are:

Two Pieces +Cropped +Short +Sleeve +Jacket +Bodice +Underneath +high-waisted +Skirt +Italy +Silk.

The words in bold and underlined carry extra weight since they were flagged as important keywords in the initial ‘training’ This allows the software tagger to rightly identify the item as a skirt and a jacket.

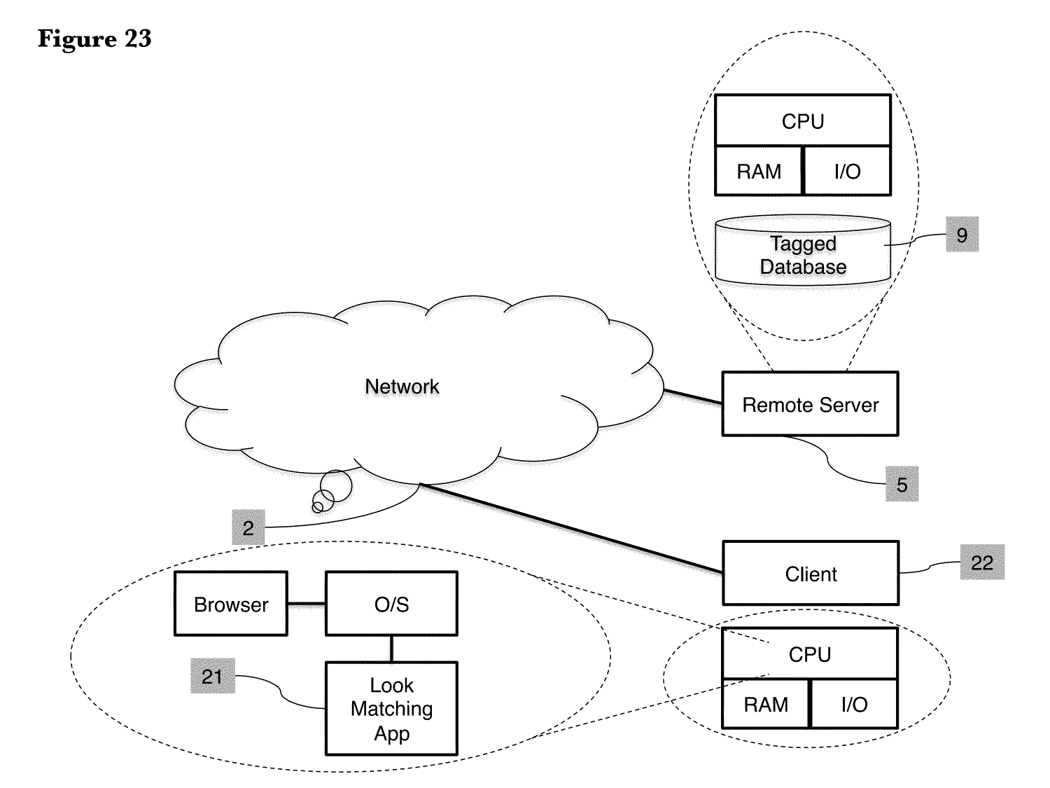

After the tagging and categorization steps, the Visual Tagger 16, is the part of the process that is run by human curators, who classify and categorize items in a way that computers cannot. The Visual Tagger 16, performs two critical operations—Feature based categorization and error check of the results produced by Software Tagger 15. The results of the 16, is sent to the database for future retrieval as shown in flow chart. FIG. 23 shows one database schema to capture the tags created by carrying out all the steps described here.

FIGS. 20 and 21 show an example the user interface for one such implementation of the visual tagging system. The first image shows, the screen of the user to who the system has suggested items that are considered by the software tagger 15 as similar. The Human Curator using system 16, considers these items and either modifies the categorization which changes the existing state of the items in the database, overwriting the categorization inferred by Software Tagger 15) or deletes the item (This operation erases the entry created by software tagger 15, and sends the item to be re-inferred and in the process tightening the Bayesian filters). FIG. 20 shows the associated interface where each image has three options for the human curator—recategorize (ReCat), Delete, or mark as completely in the wrong category (MisCat) that needs to be re-processed.

More importantly the visual tagging system allows the user to recognize and tag features related to the abstract representation of the item. For example, in FIG. 21 a human curator can classify the shoe as a “boot” that's “calf length”. The curator uses the system till all relevant structural features that make up the item are captured. In this way all items are tagged for their structural features.

FIG. 23 depicts one system for realizing the invention through a client-server architecture that uses a Look matching application to create related sets of items of creation

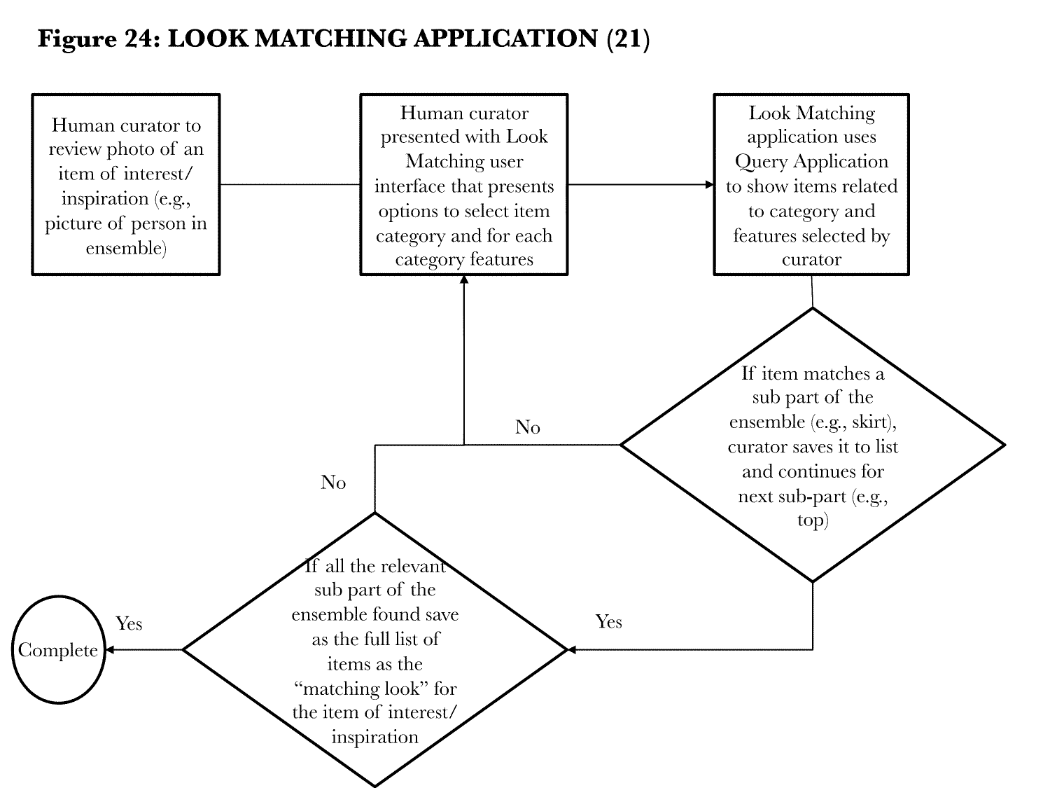

FIG. 24 depicts a flow chart of how a human curator (user) can create an ensemble that matches the look of a photograph (or other item of inspiration/interest)

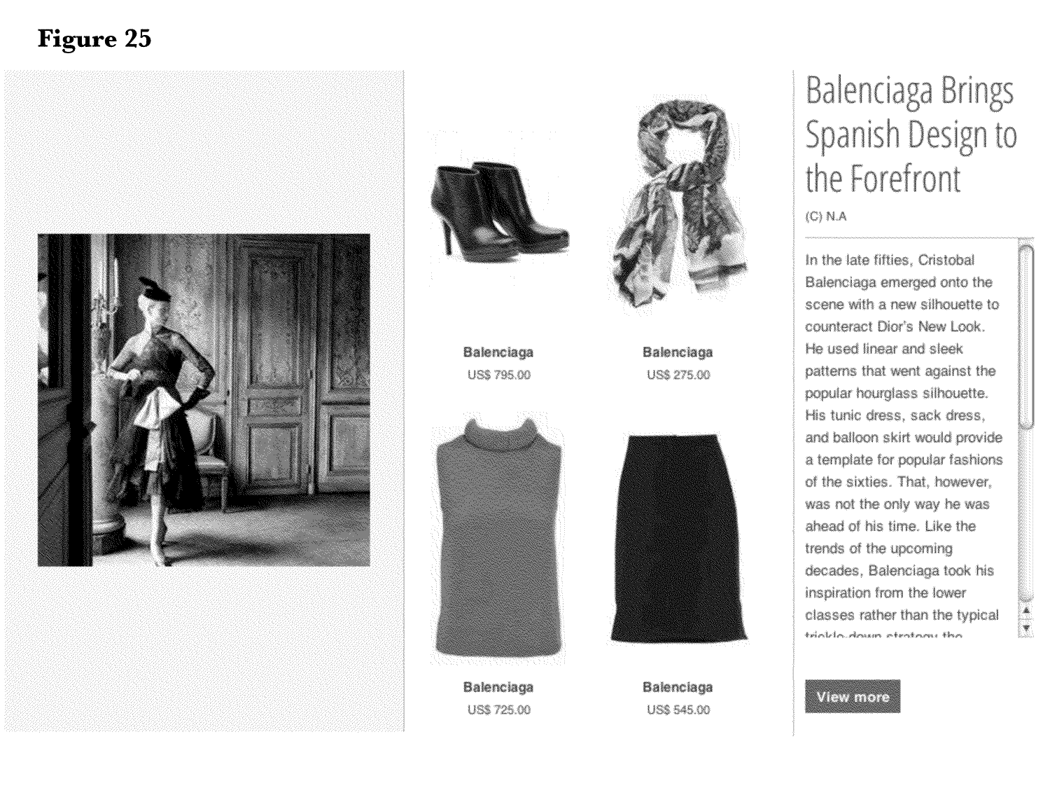

FIG. 25 depicts one example—four items that are assigned to a set of designs related to the Spanish designer Balenciaga

FIG. 23 depicts a system like that of FIG. 1 and FIG. 5 for a client that connects to a query engine that in turns uses the tagged database to find items that match the query. Like the system depicted in FIG. 1 this client is coupled to a cluster of servers via a network all in the conventional manner known in the art as adapted in accord with the teachings hereof.

The Look Matching Application (21) in FIG. 23 is different from the other applications described here. Its purpose is not to match just a single item (like the phone application or the query application) but to allow a human curator (user) to efficiently match a complete ensemble of items of creation (in this case a “look” that combines multiple items of fashion) to actual items available that are visually similar (items can be from multiple sources).

FIG. 25 shows an example output from the system. It is a set of items of creation; in this case it is a set associated with a photograph of an ensemble by the Spanish designer Balenciaga. Based on an old photograph of one of Balenciaga created “looks” (a combination of fashion items) a human curator (user) can use Look Matching Application 21 to identify items that are similar to the original photograph through successive definition of features of each item. The steps involved in finding individual items are identical to those described in FIGS. 1 and 2, the additional step is to enable the creation of a set of related items as show in FIG. 24.

Described above are systems and methods meeting the aforementioned objects. It will be appreciated that the embodiments shown in the drawings and discussed here are merely examples of the invention, and that other embodiments employing changes thereto fall within the scope of the invention, of which we claim:

In view of the foregoing, what I/we claim is:

1. A method for search of items of creation
a. displaying a visual depiction of a framework [e.g., mannequin, picture frame, rough outline of sculpture],
b. accepting specification [e.g., textual, point-and-click, or otherwise] of a feature of an item of creation to be found,
c. displaying a [e.g., visual] depiction of the framework the item with the specified feature,

2. repeating steps (B)-(C) one or more times.

3. The method of claim 1, wherein the step of accepting specification of the feature includes displaying one or more depictions of variations of the feature.

4. The method of claim 1, further including the step of generating a searchable representation of the item to be found including one or more specified features.

5. The method of claim 3, wherein the searchable representation comprises text.

6. The method of claim 4, including the step of applying the text to a search portal.

7. The method of claim 3, wherein the searchable representation comprises XML.

8. A method for search of items of creation,
a. displaying a visual depiction of a framework [e.g., mannequin, picture frame, rough outline of sculpture],
b. accepting specification [e.g., textual, point-and-click, or otherwise] of a feature of an item of creation to be found,
c. displaying a [e.g., visual] depiction of the framework the item with the specified feature,
d. repeating steps (B)-(C) one or more times, and
e. searching a data set for items matching the item to be found including one or more specified features.

9. The method of claim 9, wherein step (B) includes the step of presenting for specification of the feature one or more parameters of the item to be found.

10. The method of claim 9, wherein step (B) includes the step of presenting for specification of the feature one or more values of one or more of the parameters of the item to be found.

11. The method of claim 10, wherein step (B) includes the step of accepting as a said feature of the item to be found a said value of a said parameter.

12. The method of claim 8, wherein the data set includes tags representing features of each of one or more associated items therein.

13. A method for search of items of creation,
a. specifying, in an image [e.g., photograph, sketch], a [e.g., semantically distinct] feature of an item of creation to be found,
b. identifying [e.g., by input, by image analysis or otherwise] the item of creation,
c. searching a data set for items matching item of creation to be found including the specified feature.

14. The method of claim 13, additionally including the step of accepting specification [e.g., textual, point-and-click, or otherwise] of one or more additional features of the item of creation to be found.

15. The method of claim 13, further including the step of generating a searchable representation of the item to be found including one or more specified features.

16. The method of claim 15, wherein the searchable representation comprises text.

17. The method of claim 16, including the step of applying the text to a search portal.

18. The method of claim 15, wherein the searchable representation comprises XML.

19. A method for search of items of creation,
a. specifying, in an image [e.g., photograph, sketch], a [e.g., semantically distinct] feature of an item of creation to be found,
b. identifying [e.g., by input, by image analysis or otherwise] the item of creation,
c. searching a data set for items matching item of creation to be found including the specified feature.

20. The method of claim 19, additionally including the step of accepting specification [e.g., textual, point-and-click, or otherwise] of one or more additional features of the item of creation to be found.

21. The method of claim 20, comprising searching the data set for items matching item of creation to be found including the specified features.

22. The method of claim 21, wherein step (B) includes the step of presenting for specification of the feature one or more parameters of the item to be found.

23. The method of claim 21, wherein step (B) includes the step of presenting for specification of the feature one or more values of one or more of the parameters of the item to be found.

24. The method of claim 24, wherein step (B) includes the step of accepting as a said feature of the item to be found a said value of a said parameter.

25. A method of creating a data set of items of creation,
a. accept image an image of an item of creation,
b. identifying the item of creations
c. identifying a feature of the item of creation,
d. storing in a data set contained on a digital data storage device the image in the data set in association with one or more tags representing the identified features,
e. where step (C) includes employing Bayaesian probablility to identify a said feature based on any of an origin of the item of creation, an origin of the image, a type of the item of creation, one or more other features of the item of creation.

26. The method of claim 25, wherein the items of interest are clothing.

27. The method of claim 25, wherein step (B) includes identify the item of interest by machine vision analysis of the image.

28. The method of claim 25, wherein step (B) includes identify the item of interest by user input.

29. The method of claim 25, wherein step (B) includes identify the item of interest by its association with one or more other images.

30. The method of claim 25, wherein step (C) includes identify the item of interest by machine vision analysis of the image.

31. The method of claim 25, wherein step (C) includes identify the item of interest by user input.

32. The method of claim 25, wherein step (C) includes identify the item of interest by its association with one or more other images.

33. A method for search of items of creation,
a. displaying a visual depiction of a framework [e.g., mannequin, picture frame, rough outline of sculpture],
b. accepting specification [e.g., textual, point-and-click, or otherwise] of a feature of an item of creation to be found,
c. displaying a [e.g., visual] depiction of the framework the item with the specified feature,
d. repeating steps (B)-(C) one or more times,
e. repeating steps (B)-(D) one or more times to identify one or more additional items of creation to be found,
f. searching a data set for items matching (a) the item to be found including one or more specified features, and (b) one or more of the additional items to be found including one or more specified features thereof

34. The method of claim 34, wherein step (B) includes the step of presenting for specification of the feature one or more parameters of the item to be found.

35. The method of claim 34, wherein step (B) includes the step of presenting for specification of the feature one or more values of one or more of the parameters of the item to be found.

36. The method of claim 35, wherein step (B) includes the step of accepting as a said feature of the item to be found a said value of a said parameter.

37. The method of claim 33, wherein the data set includes tags representing features of each of one or more associated items therein.

38. The method of claim 37, wherein the tags include, for each of one or more items, parameters and values of those parameters.

39. The method of claim 38, wherein step (E) includes finding in the data set one or more items associated with a tag that includes a parameter and value matching a feature specified in step (B).

40. A method for search of items of creation,
a. specifying, in an image [e.g., photograph, sketch], a [e.g., semantically distinct] feature of an item of creation to be found,
b. identifying [e.g., by input, by image analysis or otherwise] the item of creation,
c. repeating steps (A)-(B) one or more times to identify one or more additional items of creation to be found,
d. searching a data set for items matching (a) the item to be found including one or more specified features, and (b) one or more of the additional items to be found including one or more specified features thereof

41. The method of claim 39, additionally including the step of accepting specification [e.g., textual, point-and-click, or otherwise] of one or more additional features of the item of creation to be found.

42. The method of claim 40, comprising searching the data set for items matching item of creation to be found including the specified features.

43. The method of claim 41, wherein step (B) includes the step of presenting for specification of the feature one or more parameters of the item to be found.

44. The method of claim 41, wherein step (B) includes the step of presenting for specification of the feature one or more values of one or more of the parameters of the item to be found.

45. The method of claim 44, wherein step (B) includes the step of accepting as a said feature of the item to be found a said value of a said parameter.

46. The method of claim 42, wherein the data set includes tags representing features of each of one or more associated items therein.

47. The method of claim 46, wherein the tags include, for each of one or more items, parameters and values of those parameters.

48. The method of claim 47, wherein step (E) includes finding in the data set one or more items associated with a tag that includes a parameter and value matching a feature specified in step (B).

49. Any of client devices, servers, and/or systems operating in accord with any of the foregoing claims.

50. Any of client devices, servers, and/or systems constructed and operated in accord with any of FIG. 1-25.
